(19) United States
(12) Patent Application Publication
(10) Pub. No.: US 2006/0128431 A1
(43) Pub. Date: Jun. 15, 2006

(54) Terminal adapter for associating user components and emulating a network entity

(76) Inventors: Guy Waugh, Surrey (GB); Michael Fitzgerald, County Kerry (IE); Patrick Scanlon, County Dublin (IE); Liam Kenny, County Kilkenny (IE); Richard Lord, Cork (IL); Christopher Young, Wicklow (IL); Michael Godley, County Kerry (IE); Gregory Steinmetz-Herve, County Kerry (IE)

Correspondence Address: JACOBSON HOLMAN PLLC, 400 SEVENTH STREET N.W., SUITE 600, WASHINGTON, DC, 20004, US

(21) Appl. No.: 11/349,119

(22) Filed: Feb. 8, 2006

Related U.S. Application Data
(63) Continuation of application No. PCT/IE04/00109, filed on Aug. 9, 2004.

(51) Int. Cl. H04B 1/38

(52) U.S. Cl. 455/557

(57) ABSTRACT

A communication system comprises an adapter (10) having interfaces (25-27) linked with user device components (12). A terminal controller (29) dynamically associates the components in real time to provide mobile stations. Thus, passengers of an aircraft can insert SIM cards into conveniently-located readers (22) and use in-flight entertainment i/o devices to make and receive cellular calls. The adapter (10) also has a BTS emulator (30) for direct communication with a BSC (3) with non-wireless internal network communication. This avoids the need for a mobile station to BTS wireless link.

### FIELD OF THE INVENTION

The invention relates to cellular networks particularly but not exclusively for vehicles such as ships and aircraft.

### PRIOR ART DISCUSSION

In certain circumstances wireless communications may interfere or may be perceived to interfere with other equipment internal to a craft. Also, wireless communications may interfere or may be perceived to interfere with other wireless communications equipment external to a craft. A further problem is that there is limited bandwidth available for vehicle-to-earth communication, and so use of this bandwidth must be optimised. There is therefore a requirement for a system and method to allow convenient use of cellular identity by users on ships or aircraft.

### SUMMARY OF THE INVENTION

According to the invention, there is provided a terminal adapter for a mobile network, the adapter comprising a plurality of user-side interfaces for communicating with user components, a terminal controller for dynamically associating user components connected to the interfaces to provide at least one mobile station in real time, and a mobile network entity emulator for communicating with a mobile network entity via a network-side interface. Thus, the adapter brings “logical” mobile stations of transiently associated components into the core of the mobile network. This avoids the mobile station to transceiver conventional link It also allows a limited number of sets components to be used for providing mobile communication services to a larger number of potential users.

In one embodiment, the user-side interfaces comprise an interface to audio input/output components.

In another embodiment, said interface communicates with input/output devices of an in-flight entertainment system.

In a further embodiment, the user-side interfaces include an interface to user display devices.

In one embodiment, said interface communicates with display devices of an in-flight entertainment system.

In another embodiment, the user-side interfaces include an interface to subscriber identity module readers.

In a further embodiment, said user-side interfaces include an interface to a data input/output device.

In one embodiment, the terminal controller dynamically associates user components by establishing a context in real time upon detection of insertion of a subscriber identity module in a reader user component.

In another embodiment, the context includes binding to a user interface component.

In a further embodiment, the terminal controller dynamically manages queues if the current usage requires more bandwidth than is available for the mobile network.

In one embodiment, the network side interface emulates a network entity so that the network entity with which it communicates operates in a conventional manner with internal network operations.

In another embodiment, the adapter dynamically links a mobile equipment unit with user devices to complete a mobile station.

In a further embodiment, the mobile equipment units are encoded in software.

In one embodiment, the mobile equipment units are configured in hardware.

In another embodiment, the emulator comprises a physical interface and protocol stacks to handle signalling, voice streams, and data streams.

In a further embodiment, the emulator further comprises application programming interfaces (APIs) to the protocol stacks and interface.

In one embodiment, the terminal controller communicates with the emulator via the APIs.

In another embodiment, the terminal controller dynamically binds to an API of the emulator as an operation of the context.

In a further embodiment, the emulator comprises a signalling monitor for monitoring incoming network traffic, and communicating incoming traffic information to the emulator.

In one embodiment, the signalling monitor resides between mobile network elements.

In another aspect of the invention, there is provided a mobile network communication system comprising a terminal adapter as described above and mobile network entities, at least one of which is linked with the emulator of the terminal adapter.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a diagram showing a communication system of the invention;

FIG. 2 is a diagram showing user terminal devices and a terminal adapter of the system in more detail;

FIG. 3 is a message sequence chart showing aspects of operation of the system of FIG. 2;

FIG. 4 is diagram of an alternative terminal adapter;

FIG. 5 is a message sequence chart for operation of the adapter of FIG. 4; and

FIG. 6 is a diagram of a further terminal adapter.

### DESCRIPTION OF THE EMBODIMENTS

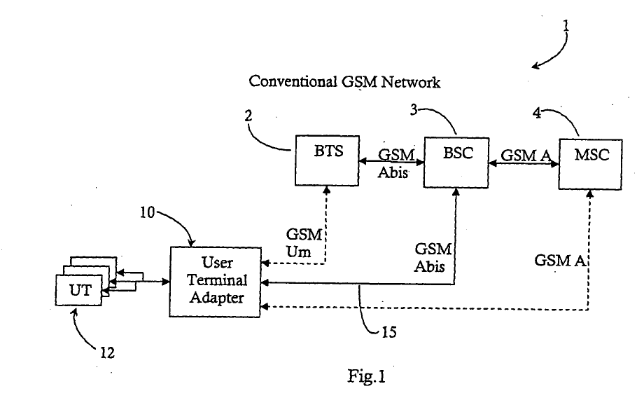

Referring to FIG. 1 a communication system 1 comprises:
a base transceiver station (BTS) 2;
a base switching centre (BSC) 3 connected to the BTS 2 by a GSM Abis interface 15; and
a mobile switching centre (MSC) 4 connected to the BSC 3 by a GSM A interface.

The system 1 further comprises a terminal adapter 10 interfacing on one side with user terminal devices 12 and on the other side with the BSC 3 via an Abis interface 15. As the interrupted lines indicate, in another embodiment an adapter is linked with the BTS 2 by a GSM Um interface, and in another embodiment an adapter is linked with the MSC 4 by a GSM A interface. The MSC communicates with an earth station via a satellite link, not shown. Thus, the system is essentially a mobile network which is movable with the vehicle or craft.

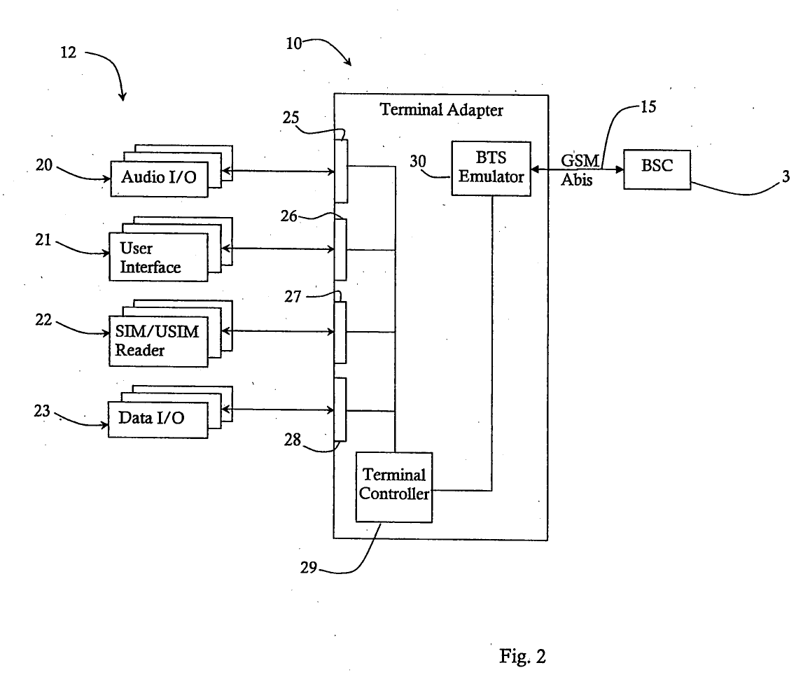

Referring to FIG. 2 on the user side of the adapter 10 the user devices 12 comprise:
20: Audio devices for use by subscribers to send and receive voice signals. These audio devices are connected to the adapter 10 using a wired link. The audio devices 20 are a combination of headset (ear piece) and microphone, such as used in in-flight entertainment (IFE) systems.
21: User interface devices to control making and receiving calls, sending and receiving messages, SIM/USIM interaction (PIN management, phone book management etc.), call register use, and other conventional cellular phone operations. These user interface devices 21 comprise a screen and keypad. The keypad may be replaced with a touch screen in one embodiment. These audio devices are connected to the adapter 10 using a wired link.
22: A SIM/USIM reader to read data from a SIM/USIM placed in it, to write data to the SIM/USIM and invoke operations on the SIM/USIM. The SIM/USIM cards are used to support conventional GSM call handling operations such as phone number storage and user authentication. The link between the SIM/USIM reader 22 and the adapter 10 is wired. In another embodiment the SIM/USIM functions can be implemented in software not requiring a physical card to be present.
23: A data input/output port for connection to user devices to make and receive data calls. These devices include but are not limited to: laptops, PDAs, telemetry devices, card readers, RFID tag readers or other computing devices needing to send or receive data over the cellular network. These audio devices are connected to the adapter 10 using a wired link.

The adapter 10 comprises internal interfaces 25, 26, 27 and 28, for communicating with the audio i/o 20, the user interfaces 21, the readers 22, and the data i/o respectively. The interfaces 25-28 each comprise a hardware port and functionality in a software terminal controller 29. The controller 29 dynamically associates the various user-side devices to provide a number of mobile stations in real time, each comprising disparate parts which are only temporarily associated. For example, every seat in an aircraft may have a set of user devices 12, some of which are also in-flight entertainment equipment. However while there may therefore be 200 sets of user devices, the controller 29 will only have several mobile stations dynamically formed at any one time. This helps to optimise use of the available satellite earth link every passenger having the option of making/receiving calls by inverting his SIM card in the reader 22, but only several stations being configured at any time.

The terminal controller 29 continuously monitors the SIM reader interface 27 for events such as SIM Present and SIM Removed. Commands and data are exchanged between the SIM reader and the controller 29 using a hardware interface. Voice signals to and from the Audio I/O devices are transcoded to and from an appropriate format (such as GSM 16 kBit/S or 64 kBit/S PCM) depending on the interface used on the network side. Data streams to and from the Data I/O devices on the user side are transcoded to and from an appropriate format (such as GSM/GPRS or GSM/CSD) depending on the interface used on the network side.

The controller 29 has an open interface for communicating with the user interface devices which can be customised to suit the user's environment. This communication is Web-based (i.e. HTTP/HTML) based. Each time a new SIM card is detected the controller 29 creates a context which identifies the particular user and network devices that need to be associated to handle the event. The controller 29 binds to any APIs that are needed such as an API to the BTS emulator 30 and an API to the user interface 21. The controller 29 uses this context and the API to route data and signalling information to and from the devices and APIs that have been associated. When the SIM is no longer present, the controller 29 releases the APIs and the devices and then deletes the context so that the devices can be used for a new session, possibly with a different SIM or user.

Thus, a passenger in an aircraft can insert his or her SIM card in a conveniently-located reader 22 and use in-flight entertainment equipment to make and receive calls. The links between the user-side components and the adapter are wireless. Also, the mobile stations are only “formed” as required and so there will be much fewer than the number of passengers. This optimises use of resources and of available bandwidth to ground.

On the network side the adapter 10 comprises a BTS emulator 30 for communicating with the BSC 3. The BTS emulator 30 comprises:
a physical interface, either IP (Ethernet) based or CEPT E1 based, to the BSC,
protocol stacks to handle signalling, voice streams, data streams and Operations & Maintenance data to and from the BSC, and
APIs to these protocol stacks and interface.

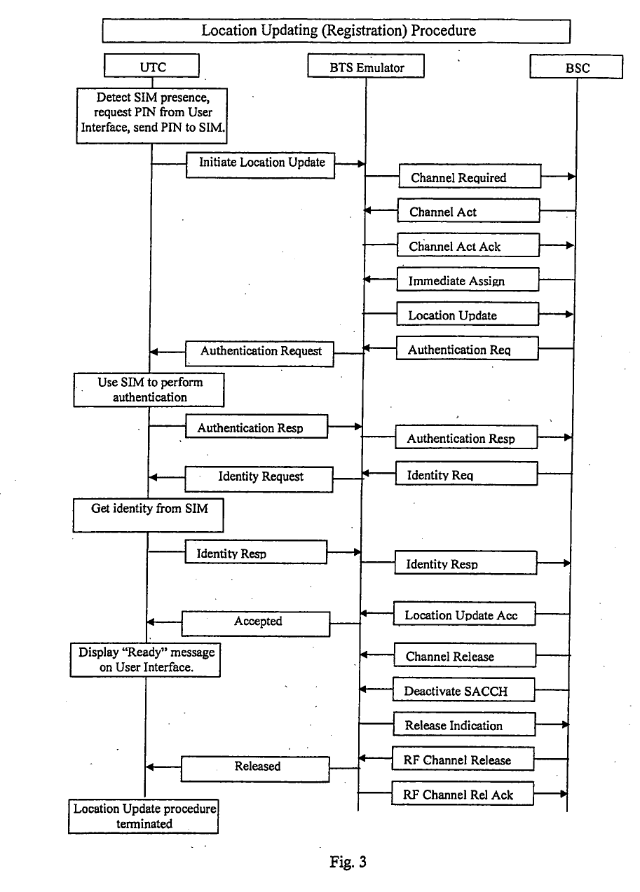

The above-mentioned APIs are used by the terminal controller 29 to exchange information between the user devices 12 and the BSC 3. An example of this interworking for a Location Updating Procedure is shown in the message sequence chart of FIG. 3. In this chart the messages exchanged between the BTS emulator 30 and the BSC 3 are standard GSM messages.

A major advantage of emulating a network element within the adapter 10 is that it allows the wireless part of the GSM network to be bypassed thereby preventing potential radio frequency interference in sensitive environments such as aircraft. Furthermore, by emulating standardised network elements it is possible to connect to unmodified cellular network entities using standard interfaces.

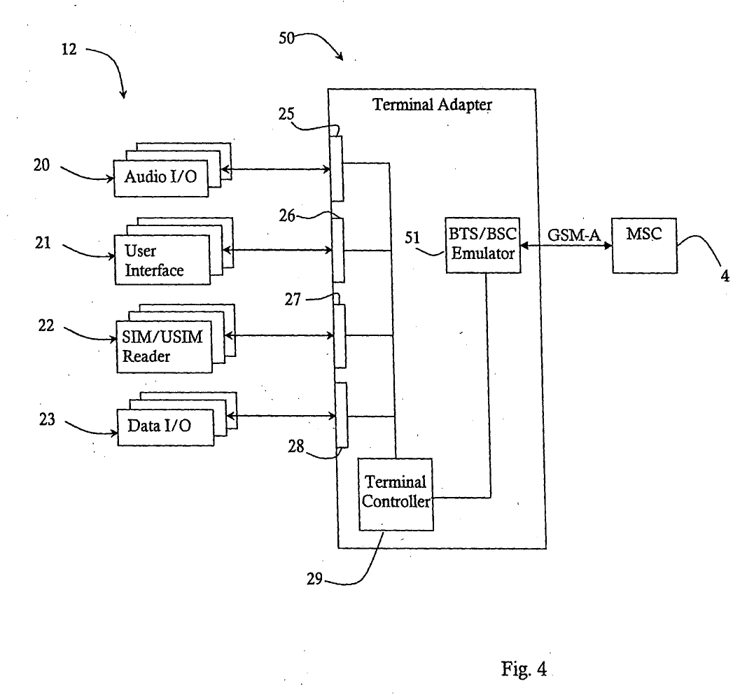

Referring to FIG. 4 a terminal adapter 50 is similar to the adapter 10 on the user side and like parts are assigned the same reference numerals. However on its network side it has a BTS/BSC emulator 51. This comprises:
a physical interface CEPT E1 based, to the MSC 4,
protocol stacks to handle signalling, voice streams, and data streams to and from the MSC 4, and
APIs to these protocol stacks and interface.

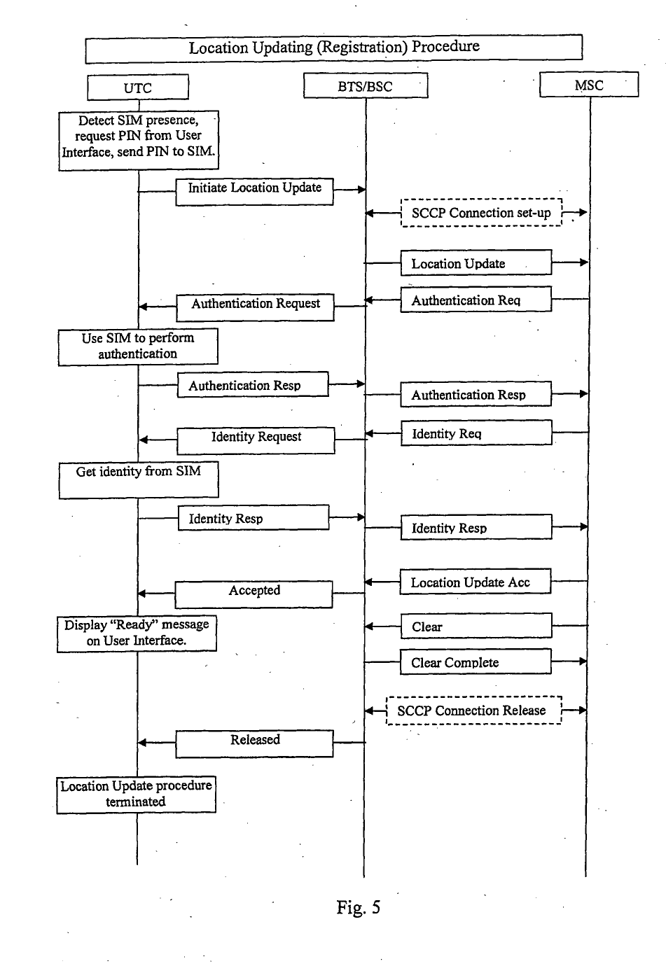

The above-mentioned APIs are used by the terminal controller 29 to exchange information between the user devices 12 and the MSC. An example of this interworking for a Location Updating Procedure is shown in the message sequence chart of FIG. 5. In this chart the messages exchanged between the BTS/BSC emulator 51 and the MSC 4 are standard GSM messages.

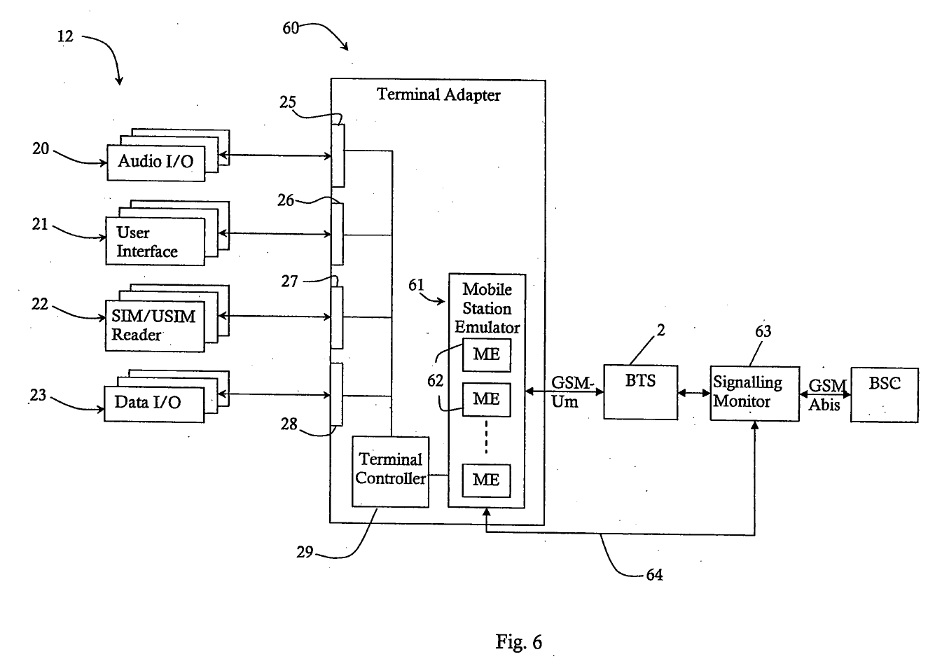

Referring to FIG. 6 a further terminal adapter 60 comprises a mobile station emulator 61. The emulator 61 comprises a number N of hardware mobile equipment units (MEs) 62 providing a GSM-Um interface to the network's BTS 2. The adapter 60 also comprises a signalling monitor 63 disposed between the BTS 2 and the BSC 3.

### Embodiment with Abis Interface (FIG. 2)

(i) Registration

The user inserts his/her SIM/USIM card into a SIM/USIM reader 22 slot. If activated on the SIM/USIM, the terminal adapter 10 prompts the user to enter the PIN number on the user interface 21. The adapter 10 detects the SIM/USIM insertion and initiates a registration procedure by sending a standard cellular registration message to the BSC 3.

The registration request is handled by the GSM entities 3 and 4 in a conventional way.

Authentication requests from the GSM network are handled by the terminal adapter 10 using the SIM/USIM in the associated SIM/USIM reader 22.

Once the registration has been acknowledged by the GSM network, the terminal adapter 10 registers the user as active.

Any information provided by the network such as TMSI is stored on the SIM/USIM.

If the procedure fails for whatever reason, the terminal adapter 10 will send an appropriate message to the user console. If the procedure is successful the terminal adapter 10 sends an indication to the user interface 21 which displays an appropriate message such as “Service Available”.

The user may now send and receive calls and messages. The user may also use services provided by the SIM/USIM such as phone-book.

(ii) Mobile Originated Service Request

Mobile originated service requests include voice calls, SMS messages, data calls, and supplementary service requests. The user composes the code for the requested service (e.g. phone number, supplementary service code) on the user interface 21 and selects the “send” option.

The adapter 10 receives the code from the user interface 21 and sends the standard service request to the GSM network. The service request is handled by the GSM network in a conventional way. If the procedure fails for whatever reason, the terminal adapter 10 will send an appropriate message to the user interface 12.

(iii) Mobile Terminated Service Request

Mobile Terminated service requests include voice calls, SMS messages, and data calls.

All users logged onto the system are registered in the GSM network as being located and camping onto the adapter 10 which behaves like a conventional GSM BTS. Incoming service requests will therefore result in the GSM network sending a paging request to the adapter 10 in the conventional way.

The user is alerted to the incoming service request by the user interface 21. In the case of a voice call the user can choose to accept or reject the request. In the case of an incoming SMS, the message will be stored in the SIM/USIM. Any information provided by the network such as caller identity is stored on the SIM/USIM. If the procedure fails for whatever reason, the adapter 10 will send an appropriate message to the user interface 21.

(iv) Detach

The user removes his/her SIM/USIM from the SIM/USIM reader 22 slot. The SI/USIM reader 22 sends a SM/USIM removal indication to the adapter 10.

The user adapter 10 sends a standard detach request to the GSM network. The detach request is handled by the GSM network in a conventional way.

If the procedure is successful the adapter 10 sends an indication to the user interface 21 which displays an appropriate message such as “Please Insert SIM/USIM⇄.

(v) SIM/USIM Services

SIM/USIM services include, but are not limited to phone-book management, security functions (PUK, chapge PIN), SIM Toolkit applications, and Java applications.

Once the user has inserted his/her SIM/USIM and entered the associated PIN code correctly all SIM services are made available to the user at the user interface 21.

### Embodiment with A Interface (FIG. 4)

In this case the adapter 10 interfaces directly with the MSC 4, and the operation is much as described above for the FIG. 2 embodiment having the Abis interface.

### Embodiment with Um Interface (FIG. 6)

Regarding the embodiment in which the adapter has a MS emulator 61, the following are the steps. It should be noted that in this embodiment there are multiple hardware mobile equipments (MES) 62, whereas in the embodiments of FIGS. 2 and 4 this functionality is implemented in software.

(i) Registration

Once the adapter 60 has successfully received the user's PIN, it assigns an ME 62 to the user for the duration of the procedure. There are typically fewer ME 62 devices than user devices 12. If no ME 62 is available the adapter 60 queues the registration request until one becomes available and then continues with the procedure. The adapter 60 is configured to give priority to different requests (registration, SMS, MT call, MO call . . . ) depending on the operator's preferences.

Once the registration procedure has been completed the ME 62 is released and is made available for other operations.

(ii) Mobile Originated Service Request

Once the adapter 60 has received the service activation from the user, it assigns an ME 62 to the user for the duration of the procedure. There are typically fewer ME devices than user devices 12. If no ME 62 is available the adapter 60 queues the MO service request until one becomes available and then continues with the procedure. The adapter 60 can be configured to give priority to different requests (registration, SMS, MT call, MO call . . . ) depending on the operator's preferences.

Once the MO Service Request procedure has been completed the ME 62 is released and is made available for other operations.

(iii) Mobile Terminated Service Request

Mobile Terminated service requests include voice calls, SMS messages, and data calls. All users logged onto the system are registered in the GSM network as being located and camping onto the adapter 10 which behaves like a conventional MS. Incoming service requests will therefore result in the GSM network sending a paging request to the adapter 60 in the conventional way.

Because the ME's 62 are allocated dynamically, the paging request is intercepted in the signalling monitor 63 which sends a message to the adapter 60 indicating the pending paging request and associated IMSI. This message is sent on the link 64.

The adapter 60 chooses an available mobile equipment 62 and associates this ME 62 with the device 12 associated with the IMSI for the duration of the procedure.

If no ME 62 is available, the adapter 60 queues the request (for a configurable time) until one becomes available and then continues with the procedure. If an ME 62 does not become available before the timer expires, the adapter 60 instructs the signalling monitor 63 to discard the paging request. The adapter 60 can be configured to give priority to different requests (registration, SMS, MT call, MO call . . . ) depending on the operator's preferences.

Once an ME 62 is ready, the adapter 60 instructs the signalling monitor to forward the pending paging request to the BTS 2. The BTS 2 pages the ME 62 in the conventional way.

Once the MT Service Request procedure has been completed the ME is released and is made available for other operations.

(iv) Detach

Once the adapter 60 has received the SIM/USIM removal indication, it assigns an - ME 61 to the user for the duration of the procedure. There are typically fewer ME devices than user devices 12. If no ME 61 is available the adapter 60 queues the registration request until one becomes available and then continues with the procedure. The adapter 60 can be configured to give priority to different requests (registration, SMS, MT call, MO call . . . ) depending on the operator's preferences.

Once the Detach procedure has been completed the ME 62 is released and is made available for other operations.

Considering the invention as a whole, it will be appreciated that the user device is directly integrated with other entities to be part of a mobile network, rather than communicating wirelessly in the conventional mobile station (MS)-to-BTS interface. This is very advantageous for environments such as aircraft, where there is the perception that wireless interfaces cause interference.

Another major advantage is that the adapter 10 coordinates operations across the user devices 12 (SIM/USIM reader, user interface, audio I/O device and data I/O port) and the GSM Abis, A, or Um interface. In GSM terms, this constitutes a virtual combined mobile station and BSS elements without any of the conventional GSM radio frequency components. It is very important that the user can use his or her own SIM or USIM card. This provides identification capability for roaming and billing, authentication for security and fraud prevention, and the card storage facilities such as phone book and personalisation information. In many cases the virtual combined mobile station can be achieved using existing facilities such as in-flight entertainment systems.

The invention is not limited to the embodiments described but may be varied in construction and detail. For example, the user devices (SIM/USIM Reader, User Interface, Audio I/O device and Data I/O device) and User Terminal Adapter 10 could be implemented as a single module. Another variation is where instead of interfacing to a GSM network using A or Abis, the -system interfaces to any other conventional cellular network such as UMTS, CDMA, TDMA, etc. in a similar fashion. Also, some communication links between devices may be wireless provided this does not introduce a risk of interference. An example is that the SIM readers may communicate with the adapter via a Bluetooth wireless interface.

1-23. (canceled)

24. A terminal adapter for a mobile network, the adapter comprising:
a plurality of user-side interfaces for communicating with user components,
a terminal controller for dynamically associating user components connected to the interfaces to provide at least one mobile station in real time, and
a mobile network entity emulator for communicating with a mobile network entity via a network-side interface,
wherein the terminal controller dynamically associates user components by establishing a context in real time upon detection of insertion of a subscriber identity module in a reader user component, the context including binding to a user interface component, and
wherein the terminal controller dynamically manages queues if the current usage requires more bandwidth than is available for the mobile network.

25. The terminal adapter as claimed in claim 24, wherein the user-side interfaces comprise an interface to audio input/output components.

26. The terminal adapter as claimed in claim 24, wherein the user-side interfaces comprise an interface to audio input/output components; and wherein said interface communicates with input/output devices of an in-flight entertainment system.

27. The terminal adapter as claimed in claim 24, wherein the user-side interfaces include an interface to user display devices.

28. The terminal adapter as claimed in claim 24, wherein the user-side interfaces include an interface to user display devices; and wherein said interface communicates with display devices of an in-flight entertainment system.

29. The terminal adapter as claimed in claim 24, wherein the user-side interfaces include an interface to subscriber identity module readers.

30. The terminal adapter as claimed in claim 24, wherein said user-side interfaces include an interface to a data input/output device.

31. The terminal adapter as claimed in claim 24, wherein the adapter dynamically links a mobile equipment unit with user components to complete a mobile station.

32. The terminal adapter as claimed in claim 24, wherein the adapter dynamically links a mobile equipment unit with user components to complete a mobile station; and wherein the mobile equipment unit is encoded in software.

33. The terminal adapter as claimed in claim 24, wherein the adapter dynamically links a mobile equipment unit with user components to complete a mobile station; and wherein the mobile equipment unit is configured in hardware.

34. The terminal adapter as claimed in claim 24, wherein the emulator comprises a physical interface and protocol stacks to handle signalling, voice streams, and data streams.

35. The terminal adapter as claimed in claim 34, wherein the emulator further comprises application programming interfaces (APIs) to the protocol stacks and interface.

36. The terminal adapter as claimed in claim 35, wherein the terminal controller communicates with the emulator via the APIs.

37. The terminal adapter as claimed in claim 24, wherein the terminal controller dynamically binds to an API of the emulator as an operation of the context.

38. The terminal adapter as claimed in claim 24, wherein the emulator comprises a signalling monitor for monitoring incoming network traffic, and communicating incoming traffic information to the emulator.

39. The terminal adapter as claimed in claim 38, wherein the signalling monitor resides between mobile network entities.

40. The mobile network communication system comprising a terminal adapter of claim 24 and mobile network entities, at least one of which is linked with the emulator of the terminal adapter.
